(19) United States
(12) Patent Application Publication
(10) Pub. No.: US 2014/0244282 A1
(43) Pub. Date: Aug. 28, 2014

(54) HEALTHCARE DATA MANAGEMENT SYSTEMS AND METHODS

(71) Applicant: Phynd Technologies, Inc., Dallas, TX (US)

(72) Inventors: Thomas White, Dallas, TX (US); Craig Williams, Woodstock, GA (US); Amanda Adams, Miller, NE (US)

(73) Assignee: Phynd Technologies, Inc., Dallas, TX (US)

(21) Appl. No.: 14/187,022

(22) Filed: Feb. 21, 2014

Related U.S. Application Data
(60) Provisional application No. 61/769,650, filed on Feb. 26, 2013.

(51) Int. Cl. G06F 19/00; G06Q 50/22

(52) U.S. Cl. CPC G06F 19/322; G06Q 50/22
USPC 705/2

(57) ABSTRACT

Methods for hospital, healthcare, and physician data management, and corresponding systems and computer-readable mediums. A method includes collecting provider data from a plurality of data sources and creating a plurality of universal provider profiles (UPPs) from the collected provider data. Each UPP corresponds to a medical provider and includes contact information for the corresponding medical provider. The method includes storing the UPPs, receiving a query, and transmitting a query response in response to the query, the query response including provider contact information from a UPP identified according to the query.

### CROSS-REFERENCE TO RELATED APPLICATION

This application claims the benefit of the filing date of U.S. Provisional Patent Application 61/769,650, filed Feb. 26, 2013, which is hereby incorporated by reference.

### TECHNICAL FIELD

The present disclosure is directed, in general, to systems and methods for managing data for hospitals, physicians, and other healthcare providers and services.

### BACKGROUND OF THE DISCLOSURE

Efficient management of data and other information related to healthcare and healthcare providers is important for cost-effective results. Improved systems are desirable.

### SUMMARY OF THE DISCLOSURE

Various disclosed embodiments include systems and methods that can automate and manage the capture, cleansing, and distribution of provider engagement (contact) information, and other information, as a “source of truth” database across a health care institution. These systems can also perform other functions related to healthcare and healthcare provider data as described herein. A method includes collecting provider data from a plurality of data sources and creating a plurality of universal provider profiles (UPPs) from the collected provider data. Each UPP corresponds to a medical provider and includes contact information for the corresponding medical provider. The method includes storing the UPPs, receiving a query, and transmitting a query response in response to the query, the query response including provider contact information from a UPP identified according to the query.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some teens may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 shows a workflow in accordance with disclosed embodiments;

FIG. 3 illustrates an example of a hardware infrastructure in accordance with disclosed embodiments; and

FIG. 4 depicts a flowchart of a process in accordance with disclosed embodiments.

### DETAILED DESCRIPTION

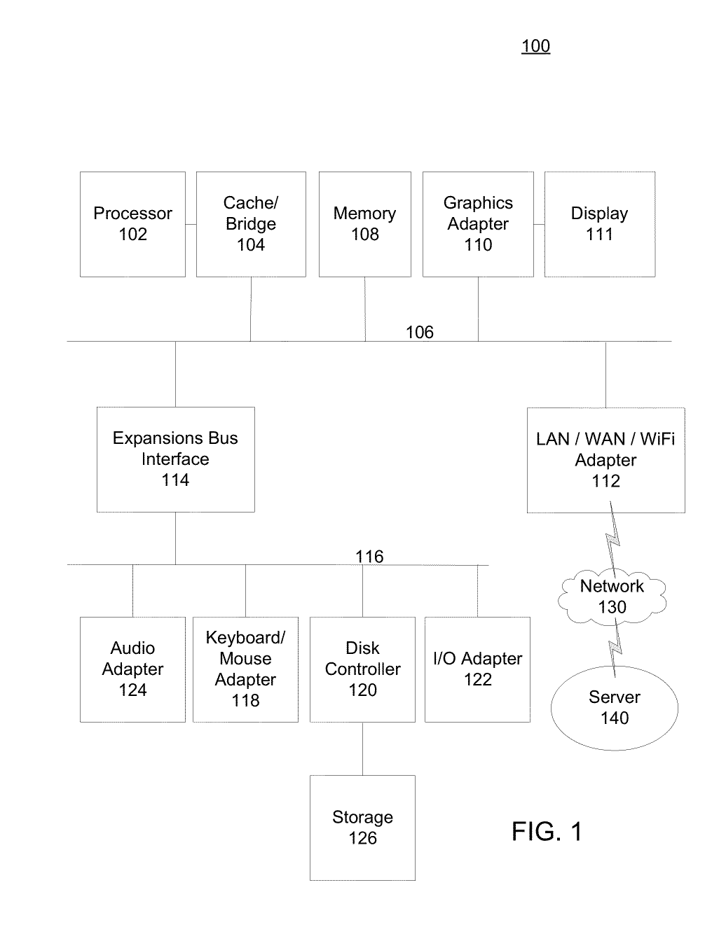

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include a Provider Management Platform (“PMP”) system enabling health care providers to interact more efficiently by offering validated contact information on their peers directly into clinical systems and personal devices. Various embodiments can interact in the electronic medical records (“EMR”) market to provide effective and efficient results to users and customers. The PMP can implement a Universal Provider Profile (UPP) for health care providers and deliver or update UPP information based on a user access or role.

Various embodiments can automate and manage, in the “cloud,” the capture, cleansing and distribution of provider engagement (contact) information as a “source of truth” database across a health care institution, preferable as a UPP. Techniques as disclosed herein can provide numerous benefits to hospitals and other entities including cost reduction, improved patient safety/compliance and a significant operational efficiency gain. Specific examples of the advantages provided by disclosed embodiments include the elimination of millions annually lost per hospital due to providers chasing communication information on other providers; mitigation of the catastrophic impact on patient safety from poor communications (the cause for 70% of all accidental deaths in a hospital); and improvement of readmission rates that cost hospitals $12 billion annually.

Another important aspect of provider engagement is content. Disclosed embodiments provide a content platform that enables hospitals to publish content to their end-users via Phynd Apps and Portals as disclosed herein. The content in the apps provide value to the providers and form a connection point between the institution and the provider. The institution can use administrative tools within Phynd to alert the providers routinely to confirm and validate their contact information and other relevant data in the UPP.

Systems and methods disclosed herein provide the source for updated contact information, verified via web portals and apps, based on engagement of end-users through uniquely created content by the provider community, preferably stored as a UPP.

Various definitions, acronyms, and abbreviations may be used herein, as follows:

| | |
|---|---|
| AES | Advanced Encryption Standard: A specification for the |
| | encryption of electronic data established by the U.S. |
| AJAX | Asynchronous JavaScript and XML: A group of interrelated |
| | web development techniques used on the client-side to create |
| | asynchronous web applications. |
| ASP.NET | A server-side Web application framework designed for Web |
| | development to produce dynamic Web pages. |
| C# | A multi-paradigm programming language encompassing |
| | strong typing, imperative, declarative, functional, generic, |
| | object-oriented (class-based), and component-oriented |
| | programming disciplines. |
| CI | Continuous Integration: The practice, in software engineering, |
| | of merging all developer workspaces with a shared mainline |
| | several times a day. |
| DTO | Data Transfer Object: A design pattern used to transfer data |
| | between software application subsystems. |
| HL7 | Health Level Seven: A framework (and related standards) for |
| | the exchange, integration, sharing, and retrieval of electronic |
| | health information. |
| HTML5 | HTML5 is a markup language for structuring and presenting |
| | content for the World Wide Web and a core technology of the |
| | Internet. |
| IIS | Internet Information Services: A web server software |
| | application and set of feature extension modules created by |
| | Microsoft for use with Microsoft Windows. |
| JQuery | A multi-browser JavaScript library designed to simplify the |
| | client-side scripting of HTML. |
| JSON | JavaScript Object Notation: A text-based open standard |
| | designed for human-readable data interchange. |
| L2E | Linq2Entity Framework |
| LINQ | Language-Integrated Query: A Microsoft .NET Framework |
| | component that adds native data querying capabilities to .NET |
| | languages. |
| MVC | Model View Controller: A software architecture pattern that |
| | separates the representation of information from the user's |
| | interaction with it. |
| ORM | Object Relational Mapping: A programming technique for |
| | converting data between incompatible type systems in object- |
| | oriented programming languages. |
| OS | Operating System: A collection of software that manages |
| | computer hardware resources and provides common services |
| | for computer programs. |
| PaaS | Platform as a Service: A category of cloud computing services |
| | that provide a computing platform and a solution stack as a |
| | service. |
| PhoneGap | A mobile development framework that enables software |
| | programmers to build applications for mobile devices using |
| | JavaScript, HTML5 and CSS3, instead of device-specific |
| | languages such as Objective-C. |
| SaaS | Software as a Service: A software delivery model in which |
| | software and associated data are centrally hosted on the cloud. |
| SHA-1 | A cryptographic hash function designed by the United States |
| | National Security Agency. |
| SSL | Secure Sockets Layer: A cryptographic protocol that provides |
| | communication security over the Internet. |
| UI | User Interface: The space where interaction between humans |
| | and machines occurs. |
| WCF | Windows Communication Foundation: A runtime and a set of |
| | APIs (application programming interface) in the .NET |
| | Framework for building connected, service-oriented |
| | applications. |
| WF | Windows Workflow Foundation: A Microsoft technology that |
| | provides an API, an in-process workflow engine, and a re- |
| | hostable designer to implement long-running processes as |
| | workflows within .NET applications. |
| WSO2 | A rules server that uses SOA to provide rules service to clients |
| Business | separating the business logic from the infrastructure code. |
| Rules | |
| Server | |

FIG. 1 depicts a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 126 can store a UPP or other data as described herein.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments, referred to as “Phynd” or the “Phynd system” in some cases, empower hospitals with the care provider information they need to improve the care provider communications and accessibility to solve clinical issues. The techniques described herein can be implemented as a Software as a Service (“SAAS”) cloud solution to deal with the issue of communications with care providers.

Phynd works by integrating with disparate “silos” of provider information (internal and external to the hospital) to match and update care provider information, creating a master database of communication/engagement information as a set of UPPs. The engagement information can be normalized and confirmed before creating or updating the corresponding UPP. The UPPs can then be provided as a wholesale data feed, front-end care provider search and directly accessible via apps/portals. Phynd allows hospitals to leverage the investment they have already made in their EMR, relationship management, credentialing and CRM software. Data flows into Phynd, and then Phynd provides multiple opportunities for the content to be consumed.

The system can connect to state, local, and EMR systems to aggregate physician/provider information, clean the data and then send it back out to EMR's also making it available via a publicly accessible API, a mobile application and website. During this process rules will be followed to determine what constitutes a duplicate entry and to try to prevent them. This, coupled with rules around who “owns” the data, allows the system to clean up and present back the master copy.

The “provider”, as used herein, can refer to any physician, nurse, or other health care provider or institution.

In various embodiments, an automated system can fetch data from state and local sources using any and all known transport systems, including but not limited to http, https, ftp, ssh, tcp, udp or a custom transport method. This data will be in various formats, including but not limited to CSV, TXT, XML, JSON, HTML, HL7 (and supporting medical formats). The data can be transformed into a specific system schema.

The following properties, some of which are medical in nature, can be used to match a provider. Matching can be used so the system doesn't create or distribute duplicate UPPs.
NPI (Provider Id)—National provider identification number.
FPI (Facility Id)—this ID can be generated based on a facility identifier and any unique ID that the facility may provide to providers who don't have a NPI number.
Provider name and date of birth.
State, city, or other geographic identifier—proximity can used to reduce the number of possible conflicts in cases where the system maintains duplicates.
Specialty within the medical field.
Common contact information, Phone/Fax/Email etc.

Data can be cleaned by applying rules as to who currently has the master data or parts of it and who can then modify the data. Once these rules are applied, the system has the master data and it is ready to be pushed/pulled according to the various options defined above.

The system can use the “ownership” of data to determine which users can modify data in a UPP. In some embodiments, the default ownership is:
Provider—an identified provider owns their data and, outside of state-controlled properties, owns and can modify their data, such as by using the Phynd website.

State—states own certain data like NPI, and changes made here by or on behalf of the state override anything else reported from another source.
Facility—changes here can only affect items not already modified by a higher chained owner and certain items again like NPI are locked only to State. They would own their FPI.

The system can use geo-location combined with provider aspects (schedule/points of contact) to specifically locate a provider and update the UPP accordingly. For example, the system can track the location of a provider and then adjust that providers schedule and contact information as represented in the UPP based on geo-location and fence proximity.

In some embodiments, when the provider is using the Phynd mobile application, the mobile application sends the provider's current location and significant location changes to a geo-location service to make use of location based services and GPS.

The system can register geo-fences with the geo-location service such as the locations of a provider's facilities. The system will be notified or will be able to query the geo-location service for the location of a provider to adjust that provider's schedule data and contact data. This data is then available for Pull via an API and can be pushed to 3rd party systems such as an EMR for automatic schedule updates.

For example, a doctor who is within the geo-fence of a hospital they work at might take all calls on a local phone or pager however if they are outside the hospital, calls are routed to their mobile or other device. This can be performed by automatic call routing or by determining, based on the location of the provider, which contact information is displayed to a user.

In various embodiments, the Phynd system can provide a service which analyzes feeds from multiple sources (external and internal) to create a master DB including Universal Provider Profiles. The system can maintain up-to-date databases with latest critical contact information through outbound functionality which confirms the known devices by asking the physicians to validate their data via apps, email and portals. The system can provide outbound engagement feeds to the EMR and other hospital systems. Phynd data can therefor act as the underlying engagement content for all systems and provider search. The system can provide value to the care providers via the Phynd applications and portal.

The applications and portals can provide care provider peer engagement information at their fingertips and can provide hospital news to keep them updated. The system can enable “My Favorites” selection so that providers can save favorite contacts. The system can implement preferences that enable users to hide a phone number by using click to call functionality.

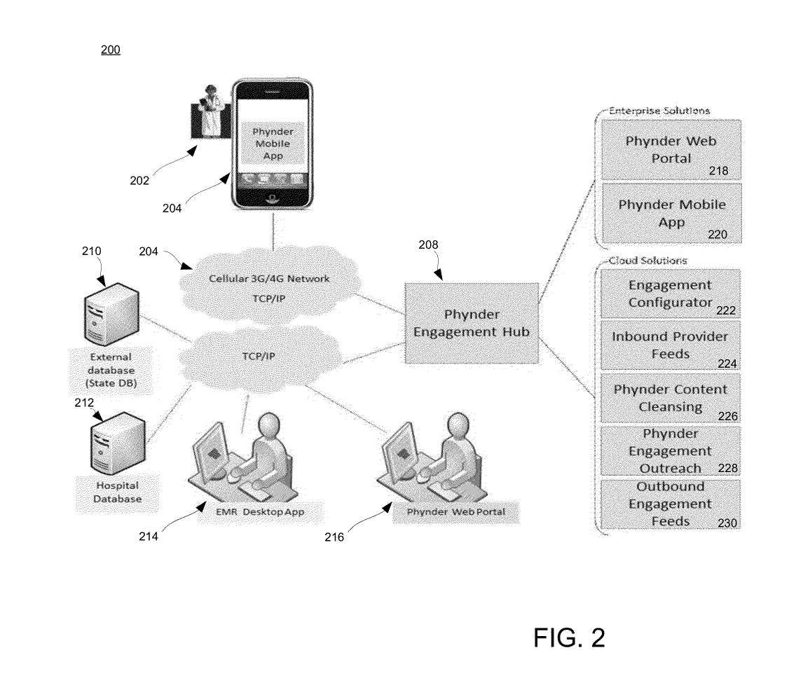

FIG. 2 shows a workflow in accordance with disclosed embodiments. In this example, a provider 202 can use a mobile device 204 with a Phynder mobile application to connect via network 206 to the Phynder engagement hub 208. Network 206 can be any public or private network(s), including wired TCP/IP networks or cellular/wireless networks, and can specifically include the Internet. The various systems shown in this figure can each be implemented using a data processing system 100.

External databases 210, such as state provider databases and others, and hospital databases 212 can also communicate over network 204 with Phynder engagement hub 208. Similarly, an electronic medical record (EMR) desktop application 214 and a Phynder Web Portal 216 can also communicate over network 204 with Phynder engagement hub 208.

Phynder engagement hub 208 can then act as an intermediary between the systems and individuals described above and the various Phynder systems to perform processes as described herein. The various Phynder systems can each be implemented on separate data processing systems, or in some cases multiple Phynder systems can be implemented on the same data processing system. Phynder systems can include enterprise solutions such as the Phynder web portal 218 and the Phynder mobile application 220, and can also include cloud solutions such as the engagement configurator 222, inbound provider fees 224, Phynder content cleansing 226, Phynder engagement outreach 228, and output engagement feeds 230.

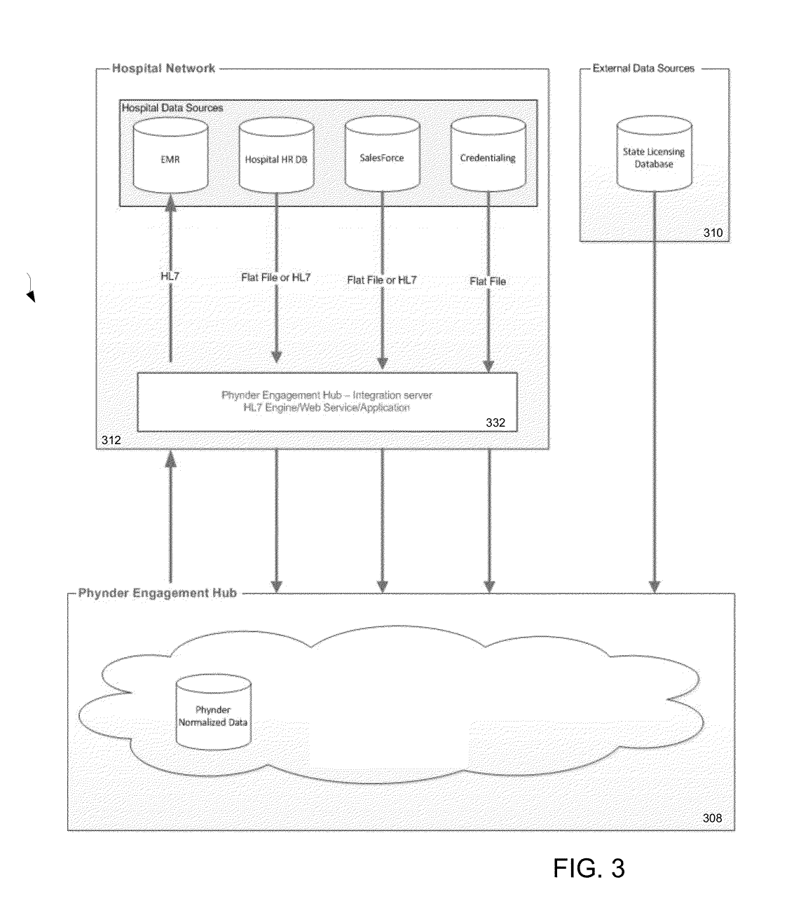

FIG. 3 illustrates an example of a hardware infrastructure in accordance with disclosed embodiments. In this example, Phynder engagement hub 308 includes Phynder normalized data as described herein, including the UPPs, and can be implemented using cloud storage and compute facilities. Phynder engagement hub 308 can communicate with external data sources 310, including state licensing databases. Phynder engagement hub 308 can also communicate with hospital networks 312, which can include hospital data sources such as electronic medical records, hospital human resources databases, customer relationship management databases, credentialing databases, and others. Each of these can be read from or written to using various file formats such as HL7, flat files, or others. The hospital network 312 can include a system 332 that acts as an integration server between the Phynder engagement hub 308 and the various hospital data sources and provides such functions as an HL7 engine, a web service, or a gateway application between to the Phynder-compatible systems and devices described herein. The various systems shown in this figure can each be implemented using a data processing system 100.

According to some embodiments, Phynd is categorized into three parts, including a Phynd Engagement hub (back end), a Phynd Web Portal (front end), and Phynd Mobile Application. Of course, those of skill in the art will recognize that the specific terms, names, and structure described below are exemplary, and other systems that perform functions as described herein are included in the scope of this disclosure.

The Phynd Engagement hub provides core functionality of the system starting with the import of the credentialing system and external sources (from such as state licensing DB). The credentialing system only accounts for the providers credentialed at the organization and not all the providers that refer patients to the health system. There is little to no engagement information provided via the credentialing system. Credentialing systems and other sources like state licensing database lack consolidated, actionable information such as updated cell phone, pager, email and back-up provider information. Phynd can collect all siloed provider information from a hospital's credentialing system and other sources like state licensing DB at regular intervals. This data can be scrubbed and normalized in the cloud at the Phynd hub server.

The core functionality that can be performed in various embodiments can include an engagement configurator, inbound provider feeds, content cleansing, a Phynd engagement manager, and Phynd engagement feeds.

An engagement configurator defines what systems can or need to be integrated with the Phynd systems described herein. It can provide connection details like server details and user login credentials. It can define what in format(s) the data will come into the system. For example, a state licensing database data may be in form of flat text file, whereas some hospital credentialing systems may send data in form of HL7. It can define what data needs to be collected, such as care providers information fields (cell-phone, email, pager, etc.). It can define the time intervals to import the data into the Phynd systems. It can include a rules interface that allows defining how, what, and when provider data should be updated.

The inbound provider feeds include the various sources of information used for the UPPs and other purposes. Phynd can collect data from various systems, including hospital systems such as credentialing systems, education databases, marketing databases and from external sources such as state license databases, the National Provider Identifier database, and others.

Systems described herein can perform content cleansing. All collected data can be scrubbed and normalized in the Phynd engagement hub based on rules defined in the engagement configurator. This process can be performed, in some embodiments, by matching and updating provider information using a unique id such as NPI ID and other variables if required. This process can also use data exceptions, so that if the required matching variable for a profile do not match then the record can be sent to an exception list that can be accessed via the Phynd web portal for further review.

Various embodiments can include a Phynd engagement manager. This feature ensures that Phynd is data up-to-date with latest critical contact information for providers such as phone, email, cell phone, pager etc. This data can be stored in the respective UPP. A Phynd outreach can routinely (the time-internal is configured by the customer) broadcast alert users to confirm their engagement data.

The system can implement Phynd engagement feeds. Phynd data can be the underlying content for all the systems and provider search, including but not limited to EMR, hospital subsystems, the Phynd mobile application, and the Phynd web portal.

Phynd web portal features can provide peer engagement information at the users fingertips, and can allow hospitals to publish news and surveys. The portal can allow creating groups to share content and to message each other. A web portal as disclosed herein will generally be used by nurses, physicians, hospital administrators. Features of Phynd Web Portal can include hospital broadcasts of news, polls, surveys, and other information. Polls and events can be real time business questions used for decision making. Providers can have the ability to view surveys and polls posted by hospital administrators and select to participate in these surveys. Users can share news on the web portal from a hospital intranet site.

The web portal can also include a search for providers. Users can search for provider information using various search options such as name, facility, etc., and the system can then return results based on the UPP, user roles, and other factors.

The web portal can also include account management for users. This section can include functions such as managing profiles, including editing and updating demographic information and managing alerts sent by hospital for device confirmation. Providers have the ability to manage their alerts.

The web portal can also allow users to manage account access. This allows users to define accessibility and viewable data points in their profile. For example, if user chooses to have their phone displayed then another user viewing their profile can click on the number to call it when using the Phynd mobile application.

The web portal can also implement administration tools. This function is mainly accessed by hospital group administrators. Group administrators can manage the rules interface, which allows administrators to configure rules and priority concerning inbound and outbound feeds. Group administrators can also manage outbound notifications, which allows administrators to configure and send out notifications for surveys, updates and general information. Notifications can be sent to devices including but not limited to email, SMS, fax, alpha pager, and the Phynd mobile application. If a user has their mobile application or device specified to be contacted then the notification goes to the mobile application.

The web portal can also implement a content publisher that can be used by a group administrator to post the news content. Content published can be for selected group, department, and role. Group administrators can post polls and surveys.

The web portal can also implement data exceptions. The system can manage data exceptions that result from data cleansing.

The web portal can also implement reporting functions. Reporting and analytics can show posted survey and poll reports, among other information.

Various embodiments include a Phynd mobile application. Mobile application access is a particular benefit of various embodiments of the Phynd system. The mobile application can be an installable application as opposed to web-based app. Features of the Phynd Mobile Application can include a search for providers, whereby users can search for provider information using various search options such as name, facility, etc. Such data can be searched and retrieved from the UPPs.

The mobile application can receive hospital news, including broadcast content from the hospital intranet, surveys, and polls. An administrator can use the web portal to post such polls and surveys.

The mobile application can also be used for account management as described herein. Disclosed embodiments are designed to allow for reusability, extensibility and maintainability. Various embodiments are object-oriented and designed following industry best practices to promote scalability. The Web services layer can be used as the data exchange mechanism for the mobile site and also potentially the data exchange mechanism for multiple external systems. The mobile application can make use of geo-location tracking if the user permits. The database can allow easy addition of new data sources. The application can be designed following best practices for security; for example, all data exchanged with external sources can be done via SSL.

The system can be implemented as a multi-layered architecture, with well-defined data access, service, rules and presentation components. The web user interface can be built using ASP.NET MVC 4. The mobile user interface can be built using HTML5, Sencha and PhoneGap. The web services can be built using Web.API services. The rules layer can utilize Windows Workflow, WSO2, or others. The data layer can use repositories to communicate with the SQL Server using our schema. Back-end data processing can be done through a basic console application that can be implemented as a Windows service. Of course, these are exemplary implementations, and other standards, software, languages, and technologies can be used.

The data access layer can incorporate all the data access and persistence logic. It can be implemented, for example, using the Linq2Entity Framework and referenced in code using LINQ syntax. This approach ensures good practices especially focused on SQL security and connection management.

The LINQ statements can be abstracted using simple repositories representing each domain object and abstracting away from the use of the L2E entities. Each domain model can have a simple class representing this and used by the repository. The repositories are not necessarily to be made generic and should be entity focused.

The data access layer can be directly referenced from the calling project as an InProc dll. The LINQ to SQL entities need not be exposed beyond the data access layer. Data transfer objects (DTO) can be used to pass and get data from the Repository classes.

Service Layer: The service implementation layer can implement and expose all the business functions and rules functions required by the Web application, Mobile application and external data exchange component. This can be implemented as a Web.API RESTful service using HTTPS as the data transmission protocol and JSON as the data transmission format.

Rules Layer: The rules layer can be implemented utilizing Windows Workflow, the WSO2 Business Rules Server, or otherwise. This layer is accessible from the services layer and the data processing layer and can be configured to govern when specific data displays at the presentation layer and how data is processed at the processing layer.

Rules can be administered from either the administrative section of the Web site or from a provided administration interface—depending on need in administration and complexity of rules.

Web Presentation Layer: All Web presentation can be handled using ASP.NET MVC 4 or otherwise. The Web site can be hosted on a Windows Server 2008 R2 machine using IIS 7.x as the application server, in some cases.

This site exposes the Views that Phynd providers, contact administrators, and super administrators can access. It can be built as a web application containing subfolders for Views, Controllers and Models. The Models specific to a View can be clubbed together as View Model. It can use the service layer for invoking business functionality and determining the data to be displayed based on rules.

Mobile Presentation Layer: All mobile presentation can be handled via HTML5 and PhoneGap for Android, iOS and Blackberry devices, or using other technologies. Services can render data as needed to the mobile presentation layer.

Data Processing Layer: This layer can be comprised of various Windows services that can be utilized to pull data from health system, state and national systems and send data to specific configured sources. This layer can use rules to determine the priority of data for specific fields and also trigger notifications on specific changes.

Notifications Layer: This layer can be comprised of the alerting Windows service which generates event-based notifications to emails, phones and faxes. This layer can access data through the data access layer and send messages as specified.

The security for a PaaS application as disclosed herein can deal with one or more of authentication at all exposed application points, roles and permissions, validating inputs, using encryption and hashing when appropriate, and server-side security and data storage.

Authentication can be utilized for publicly facing applications within this system. Passwords can be hashed—this can be taken care of by the membership provider. Sensitive data should be encrypted using AES for storage. Any fields needing encryption can be designated in the non-functional requirements. Role and permissions can be checked each time restricted information is requested or submitted. Some type of authentication should be required for each service-layer request. SSL can be utilized to secure all data transferred in this system externally.

Error messages on the site should be friendly but should avoid giving information that would help a user determine valid usernames, ids, passwords, etc. on the site. Servers that host components which are only accessible internally can be locked via a DMZ style setup.

User inputted data can be displayed using HTML encoding and can be validated before transmission to the server. A user-specific, session-specific token can be included in both GET and POST requests accessing restricted data—this is taken care of by ASP.NET.

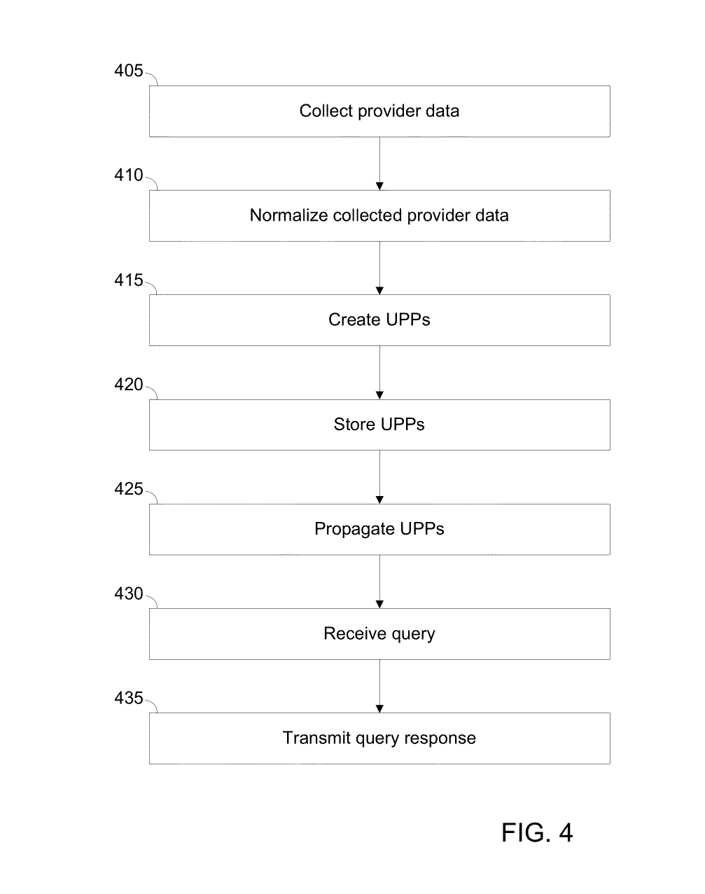

FIG. 4 depicts a flowchart of a process in accordance with disclosed embodiments that can be performed by a healthcare data management system and implemented by one or more data processing systems as disclosed herein, simply referred to as “the system” below.

The system collects provider data from one or more data sources (405). The sources can include state medical licensing databases, hospital data sources, and others.

The system can normalize the collected provider data to produce normalized provider data (410). This can include converting collected data in different formats or from different sources into a normalized format. The normalization can be performed according to defined rules, and can include data exception processes as described herein.

The system creates a plurality of universal provider profiles (UPPs) from the collected provider data or the normalized provider data (415). Each UPP identifies a medical provider by a unique identifier, which can be or include, for example, a national provider identification number (NPI), an identifier assigned by a medical facility in combination with a facility identifier, a provider name in combination with the provider's date of birth, a geographic identifier, a medical specialty identifier, or other identifier sufficient to uniquely identify the UPP and corresponding medical provider apart from other UPPs or providers in the normalized provider data. The UPP can include licensing information for the corresponding medical provider. Each UPP can include data for the corresponding provider that is combined from multiple date sources.

The UPP can also include contact information for the corresponding medical provider. The contact information can include data such as telephone numbers, fax numbers, and email addresses for the provider, and can include other contact information such as the telephone numbers of facilities, departments, and other locations in which the provider is likely to be working at a given time. The contact information can include geographic information associated with one or more of the numbers or addresses, which can be used to assign an immediate contact method based on the current geographic location of the provider. The contact information can include scheduling information associated with one or more of the numbers or addresses, which can be used to assign an immediate contact method based on the current time and date and likely current location of the provider. The UPP can include communication priority information that indicates the order in which different contact information for the provider should be used according to a contact priority, such as whether the contact needed is for a life-threatening emergency or otherwise. The contact information can include an on-call indicator that indicates whether the provider is on call at a given time, and can indicate which contact information to use while the provider is on call.

Creating the plurality of UPPs can include quality control processes, such as displaying the created UPPs to a quality-control user for validation and receiving an approval from the quality-control user.

The system stores the plurality of UPPs (420).

The system can propagate the UPPs to one or more external systems (425). These systems can include hospital systems.

The system can receive a provider query (430). This query can be received, for example, from a user via a web portal or mobile application. The query can be based on any of the data stored in the UPP.

In response to the query, the system can transmit a query response (435). The query response can include provider contact information from a UPP identified according to the query. The provider contact information can be based on the current time and date, the current location of the provider corresponding to the identified UPP, the contact priority, or the on-call indicator in the identified UPP.

Of course, those of skill in the art will recognize that, unless specifically indicated or required by the sequence of operations, certain steps in the processes described above may be omitted, performed concurrently or sequentially, or performed in a different order. Similarly, others of the processes and functions described herein can be performed by the system in conjunction with the processes of FIG. 4.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of foams, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method performed by one or more data processing systems, comprising:
collecting provider data, by the one or more data processing systems, from a plurality of data sources;
creating a plurality of universal provider profiles (UPPs) from the collected provider data, each UPP corresponding to a medical provider and including contact information for the corresponding medical provider;
storing the UPPs in the one or more data processing systems;
receiving a query; and
transmitting a query response in response to the query, the query response including provider contact information from a UPP identified according to the query.

2. The method of claim 1, wherein the one or more data processing systems also normalize the collected provider data to produce normalized provider data, and the UPPs are created from the normalized provider data.

3. The method of claim 1, wherein the UPP identifies the corresponding medical provider by a unique identifier.

4. The method of claim 3, wherein the unique identifier includes at least one of a national provider identification number (NPI), an identifier assigned by a medical facility in combination with a facility identifier, a provider name in combination with the provider's date of birth, a geographic identifier, or a medical specialty identifier.

5. The method of claim 1, wherein each UPP includes data for the corresponding medical provider that is combined from the plurality of data sources.

6. The method of claim 1, wherein the contact information includes geographic information associated with one or more telephone numbers or email addresses, and is used to assign the provider contact information in the query response based on a current geographic location of the corresponding medical provider.

7. The method of claim 1, wherein the contact information includes scheduling information associated with one or more telephone numbers or email addresses, and is used to assign the provider contact information in the query response based on a current time and date and likely current location of the provider.

8. The method of claim 1, wherein the UPP includes communication priority information that indicates the order in which different contact information for the corresponding medical provider should be used according to a contact priority.

9. The method of claim 1, wherein the contact information includes an on-call indicator that indicates whether the corresponding medical provider is on call at a given time, and indicates which contact information to use while the provider is on call.

10. The method of claim 1, wherein the query is received from a user via one of web portal and a mobile application.

11. A healthcare data management system including one or more data processing systems, each data processing system comprising:
at least one processor; and
an accessible memory,
the healthcare data management system particularly configured to collect provider data from a plurality of data sources;
create a plurality of universal provider profiles (UPPs) from the collected provider data, each UPP corresponding to a medical provider and including contact information for the corresponding medical provider;
store the UPPs;
receive a query; and
transmit a query response in response to the query, the query response including provider contact information from a UPP identified according to the query.

12. The healthcare data management system of claim 11, wherein the one or more data processing systems also normalize the collected provider data to produce normalized provider data, and the UPPs are created from the normalized provider data.

13. The healthcare data management system of claim 11, wherein the UPP identifies the corresponding medical provider by a unique identifier.

14. The healthcare data management system of claim 13, wherein the unique identifier includes at least one of a national provider identification number (NPI), an identifier assigned by a medical facility in combination with a facility identifier, a provider name in combination with the provider's date of birth, a geographic identifier, or a medical specialty identifier.

15. The healthcare data management system of claim 11, wherein each UPP includes data for the corresponding medical provider that is combined from the plurality of data sources.

16. The healthcare data management system of claim 11, wherein the contact information includes geographic information associated with one or more telephone numbers or email addresses, and is used to assign the provider contact information in the query response based on a current geographic location of the corresponding medical provider.

17. The healthcare data management system of claim 11, wherein the contact information includes scheduling information associated with one or more telephone numbers or email addresses, and is used to assign the provider contact information in the query response based on a current time and date and likely current location of the provider.

18. The method of claim 1, wherein the UPP includes communication priority information that indicates the order in which different contact information for the corresponding medical provider should be used according to a contact priority.

19. The healthcare data management system of claim 11, wherein the contact information includes an on-call indicator that indicates whether the corresponding medical provider is on call at a given time, and indicates which contact information to use while the provider is on call.

20. The healthcare data management system of claim 11, wherein the query is received from a user via one of web portal and a mobile application.
